(19) United States
(12) Patent Application Publication
(10) Pub. No.: US 2016/0360918 A1
(43) Pub. Date: Dec. 15, 2016

(54) Rotary tea maker

(71) Applicants: Han Tsung Chen, Taichung (TW); Hsiu Lan Lu, Taichung (TW); Wei Fu Chen, Taichung (TW)

(72) Inventors: Han Tsung Chen, Taichung (TW); Hsiu Lan Lu, Taichung (TW); Wei Fu Chen, Taichung (TW)

(21) Appl. No.: 15/247,871

(22) Filed: Aug. 25, 2016

(51) Int. Cl. A47J 31/20; A47J 31/00; A47J 31/06; A23F 3/18

(52) U.S. Cl. CPC A47J 31/20; A23F 3/18; A47J 31/005; A47J 31/0615

(57) ABSTRACT

A rotary tea maker includes a tea cup and a tea infuser. After the tea is brewed in a tea brewing room of the tea infuser, through rotation of the tea infuser, the tea is discharged from the tea brewing room to be stored in a tea room of the tea cup for use. The tea in the tea brewing room flows to a passage from a water outlet of the tea infuser and then enters the tea room from a through hole of the tea cup. During the process, the air in the tea room is expelled to the passage from the through hole when the tea is poured and then flows to the tea brewing room through an air hole of an air pipe of the tea infuser, so that the tea in the tea brewing room can be discharged to the tea room smoothly.

### BACKGROUND OF THE INVENTION

1. Field of the Invention

The present invention relates to a rotary tea maker, and more particularly to a rotary tea maker having a tea cup and a tea infuser. The tea in a tea brewing room of the tea infuser can be discharged to a tea room of the tea cup smoothly.

2. Description of the Prior Art

In case tea leaves are infused too long, the flavor of the tea is affected. In general, a tea pot is used for making tea. The brew is poured to a lipped cup and then poured to everyone's cup through the lipped cup. There are various tea pots on the market. Tea pots are continually improved for the brew to be poured to a lipped cup conveniently. However, no matter how the structure of the tea pot is improved, it is necessary to use many bottles, pots and tea cups when making tea. This is very inconvenient for a person to make tea outdoors. A conventional rotary tea maker comprises a rotary tea infuser which can prevent tea leaves from infusing too long. The operation for the tea to be discharged from a tea brewing room to a tea room of a tea cup is convenient. But, the structure of discharge and water-blocking uses a complicated switch, which is not beneficial for production. There is another conventional rotary tea maker. Although the structure is innovated and simplified, the air in the tea room cannot be expelled to the outside when the tea in the tea brewing room is discharged to the tea room. Because the air in the tea room cannot be expelled to the outside or cannot flow to the tea brewing room from a through hole of the tea room along the passage, the air is accumulated in the passage to hinder the water outlet from discharging the tea. As a result, the tea cannot be discharged smoothly. Sometimes, even though the passage is opened, the tea in the tea brewing room cannot be discharged to the tea room normally. Accordingly, the inventor of the present invention has devoted himself based on his many years of practical experiences to solve these problems.

### SUMMARY OF THE INVENTION

The primary object of the present invention is to provide a rotary tea maker. The rotary tea maker includes a tea cup and a tea infuser. A bottom end of the tea cup is provided with a detachable bottom cover. An upper portion of the tea cup is provided with a partition therein to partition the tea cup into a tea room and a coupling trough. The partition is formed with a through hole for the tea room to communicate with the coupling trough. An inner wall of the coupling trough is formed with inner threaded portion. A top end of the tea infuser is provided with a detachable upper cover. The tea infuser has a tea brewing room therein and a bottom portion at a lower end thereof. An outer wall of the bottom portion is formed with an outer threaded portion to mate with the inner threaded portion of the tea cup. The bottom portion is further formed with a water outlet which is disposed to stagger the through hole of the tea cup. The bottom portion of the tea infuser is formed with an air pipe extending toward the tea brewing room to approach the upper cover. The air pipe and the through hole of the tea cup are staggered. The air pipe has an air hole therein, enabling the bottom portion to communicate with the tea brewing room. When the upper cover is opened and tea leaves are placed into the tea infuser, the tea leaves are brewed in the tea brewing room of the tea infuser because the water outlet of the tea infuser and the through hole of the tea cup are staggered and not in communication with each other. In order to prevent the tea leaves from infusing too long, the tea infuser can be turned anytime for the outer threaded portion to disengage from the inner threaded portion of the tea cup to form a passage between the bottom portion of the tea infuser and the partition of the tea cup, such that the water outlet is in communication with the through hole and the tea in the tea brewing room of the tea infuser flows from the water outlet through the passage and the through hole to enter the tea room of the tea cup. For next tea brewing, the tea infuser is turned reversely, enabling the outer threaded portion of the tea infuser to engage with the inner threaded portion of the tea cup. The passage between the water outlet and the through hole is closed, so that the water outlet is not in communication with the through hole. The user can invert the tea cup and open the bottom cover to drink the tea in the tea room. After the tea is brewed in the tea brewing room of the tea infuser each time, through rotation of the tea infuser, the tea is discharged from the tea brewing room to be stored in the tea room for use. The tea in the tea brewing room flows to the passage from the water outlet and then enters the tea room from the through hole. During the process, the air in the tea room is expelled to the passage from the through hole when the tea is poured and then flows to the tea brewing room through the air hole of the air pipe, so that the tea in the tea brewing room can be discharged to the tea room smoothly.

Preferably, the outer wall of the bottom portion of the tea infuser is further formed with a neck portion. The neck portion is provided with an annular engaging rib. The engaging rib is coupled with a soft rubber member. The soft rubber member has a rubber plate attached to the bottom surface of the bottom portion. The rubber plate has a perforation and a vent corresponding to the water outlet and the air hole respectively. When the outer threaded portion of the tea infuser and the inner threaded portion of the tea cup are locked tightly, the rubber plate of the soft rubber member is compressed between the bottom portion and the partition to improve the sealing function for blocking the communication between the water outlet and the through hole as well as the communication between the air hole and the through hole. When the tea is brewed in the tea brewing room of the tea infuser, the tea won't flow to the tea room of the tea cup.

Preferably, the tea infuser is further provided with a filter screen disposed above the water outlet of the bottom portion. The filter screen is configured to filter the tea leaves when the tea in the tea brewing room of the tea infuser is discharged to the tea room of the tea cup through the passage.

Preferably, the air pipe is provided with a reinforcement piece connected with the inner wall of the tea brewing room of the tea infuser. The reinforcement piece is to reinforce the connection between the pipe wall of the air pipe and the inner wall of the tea brewing room. When the tea leaves are brewed in the tea brewing room, the air pipe can be kept uprightly in the tea brewing room through the reinforcement piece.

Preferably, the bottom cover has a faceplate. The faceplate is formed with an outlet. An outer side of the faceplate is pivotally connected with a lid. One end of the lid is provided with a plug facing the outlet. The plug is plugged into the outlet to seal the outlet when the tea room is stored with the tea. When the tea cup is inverted, the lid can be pivoted and opened and the plug is disengaged from the outlet, so that the tea in the tea room can be poured out conveniently and quickly from the outlet for use.

### BRIEF DESCRIPTION OF THE DRAWINGS

FIG. 1 is an exploded view in accordance with a preferred embodiment of the present invention;

FIG. 2 is a sectional view in accordance with the preferred embodiment of the present invention;

FIG. 3 is a sectional view taken along line A-A of FIG. 2;

FIG. 4 is a schematic view in accordance with the preferred embodiment of the present invention, showing that the tea leaves are brewed;

FIG. 5 is a schematic view in accordance with the preferred embodiment of the present invention, showing that the tea flows to the tea cup;

FIG. 6 is a schematic view in accordance with the preferred embodiment of the present invention, showing that the passage is closed to prevent the tea from flowing back to the tea infuser; and

FIG. 7 is a schematic view in accordance with the preferred embodiment of the present invention, showing that the lid of the tea cup is opened.

### DETAILED DESCRIPTION OF THE PREFERRED EMBODIMENTS

Embodiments of the present invention will now be described, by way of example only, with reference to the accompanying drawings.

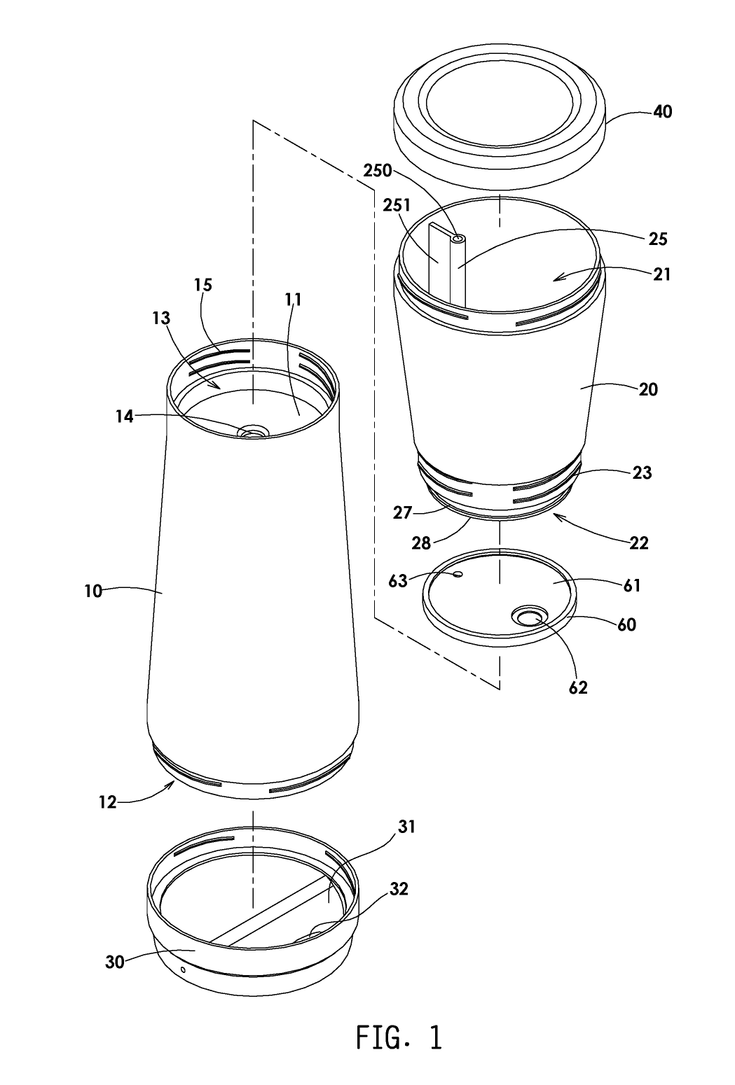

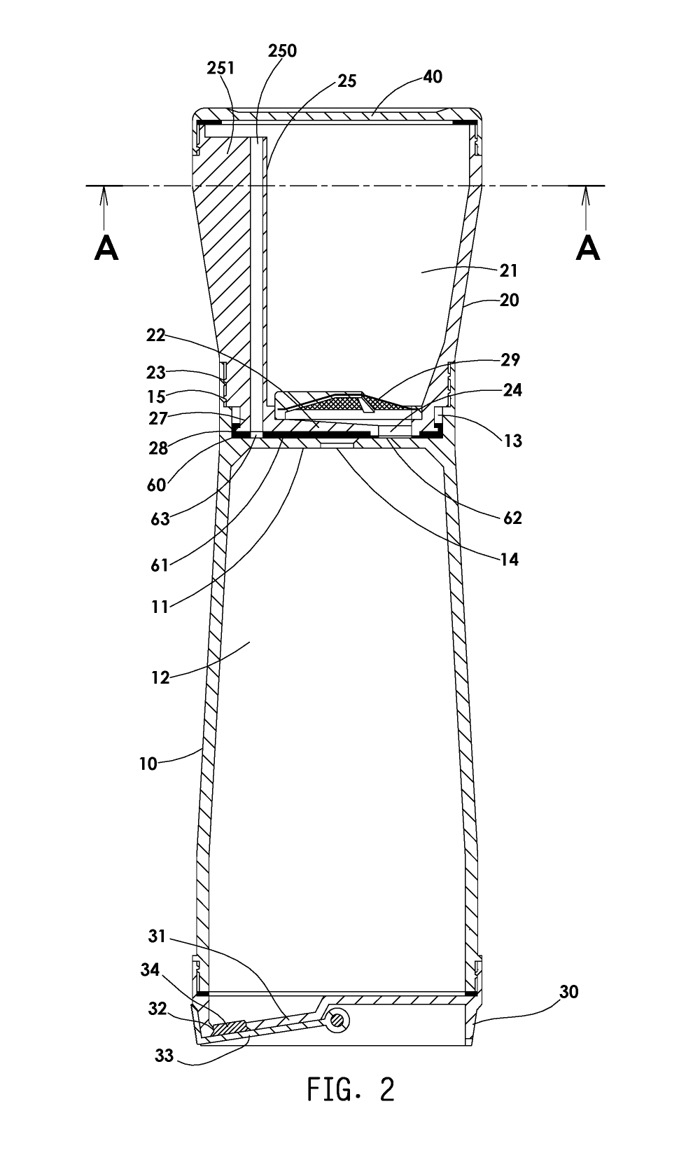

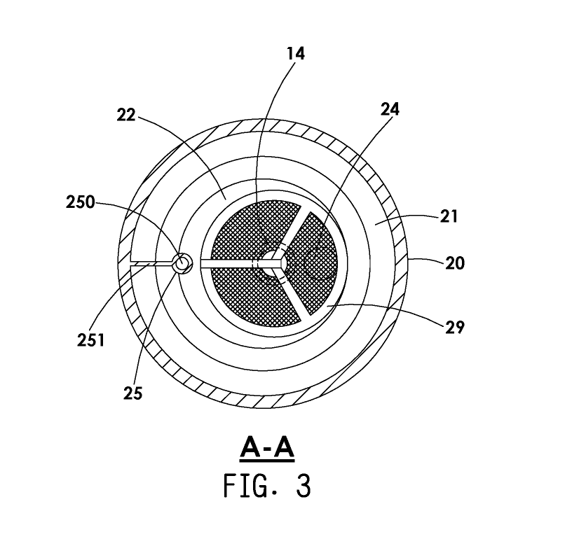

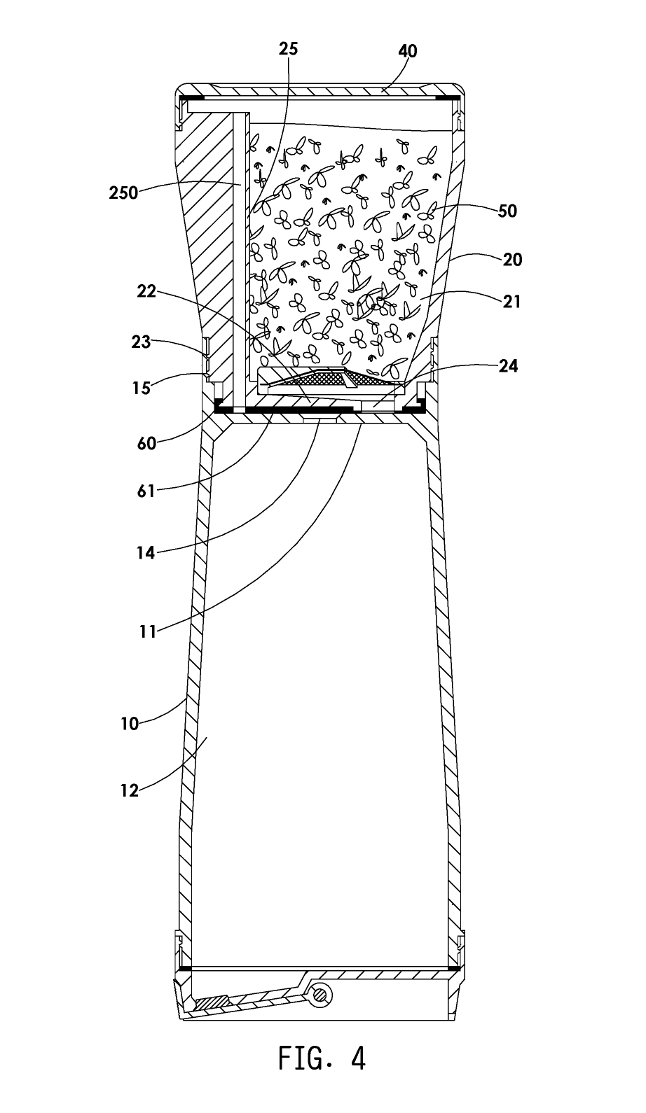

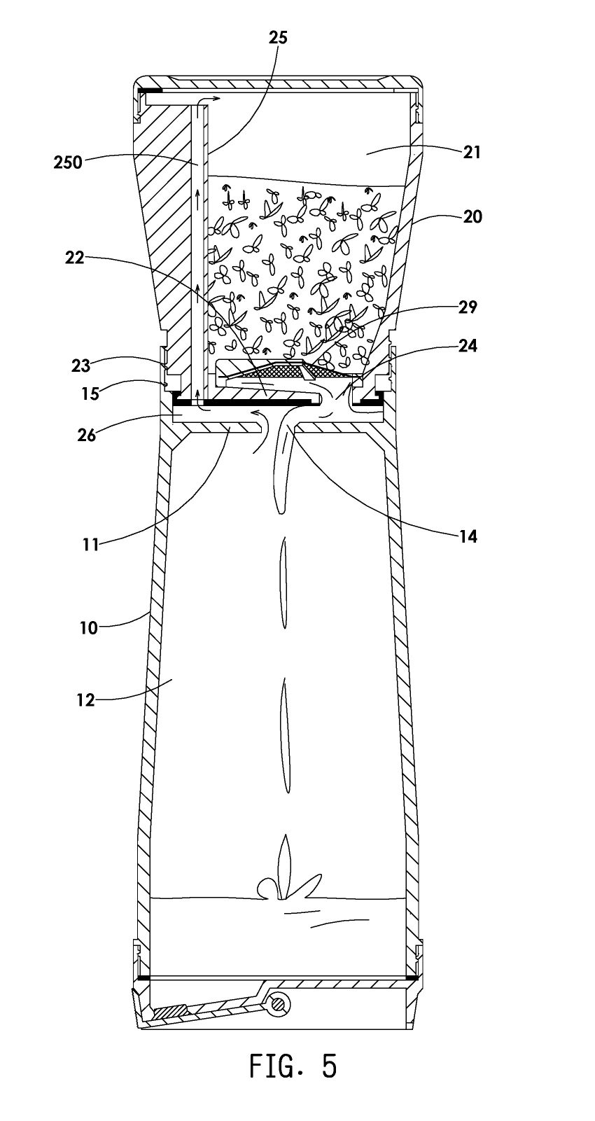

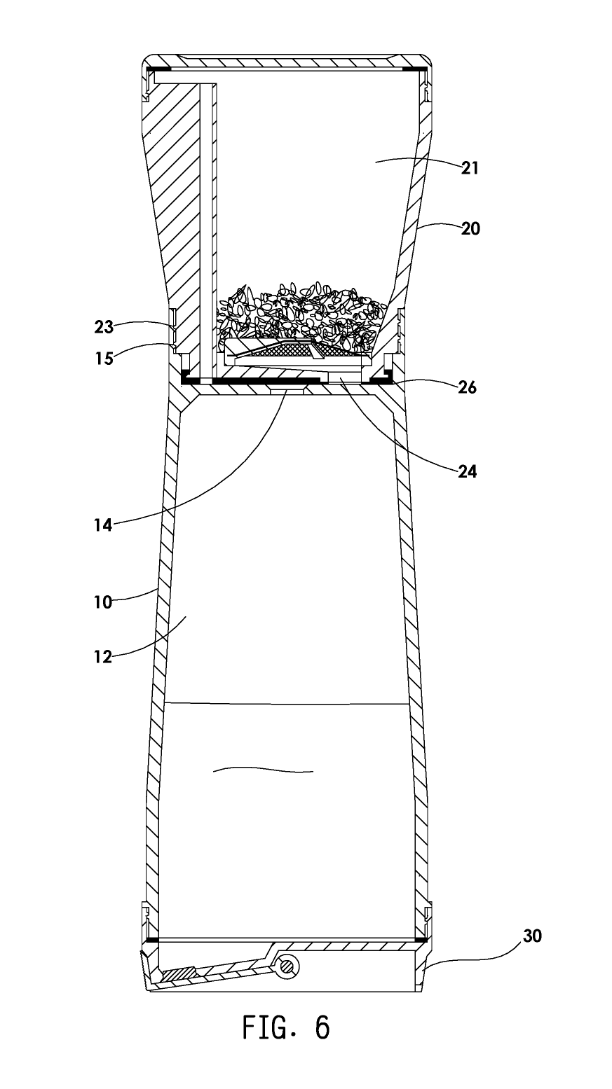

As shown in FIG. 1, FIG. 2 and FIG. 3, the present invention discloses a rotary tea maker. The rotary tea maker includes a tea cup 10 and a tea infuser 20. A bottom end of the tea cup 10 is provided with a detachable bottom cover 30. An upper portion of the tea cup 10 is provided with a partition 111 therein to partition the tea cup 10 into a tea room 12 and a coupling trough 13. A central portion of the partition 111 is formed with a through hole 14 for the tea room 12 to communicate with the coupling trough 13. An inner wall of the coupling trough 13 is formed with inner threaded portion 15. A top end of the tea infuser 20 is provided with a detachable upper cover 40. The tea infuser 20 has a tea brewing room 21 therein and a bottom portion 22 at a lower end thereof. An outer wall of the bottom portion 22 is formed with an outer threaded portion 23 to mate with the inner threaded portion 15 of the tea cup 10. The bottom portion 22 is further formed with a water outlet 24 which is eccentrically disposed to stagger the through hole 14 of the tea cup 10. The bottom portion 22 of the tea infuser 20 is formed with an air pipe 25 extending toward the tea brewing room 21 to approach the upper cover 40. The air pipe 25 and the through hole 14 of the tea cup 10 are staggered. The air pipe 25 has an air hole 250 therein, enabling the bottom portion 22 to communicate with the tea brewing room 21. As shown in FIG. 4, when the upper cover 40 is opened and tea leaves 50 are placed into the tea infuser 20, the tea leaves 50 are brewed in the tea brewing room 21 of the tea infuser 20 because the water outlet 24 of the tea infuser 20 and the through hole 14 of the tea cup 10 are staggered and not in communication with each other. In order to prevent the tea leaves 50 from infusing too long, the tea infuser 20 can be turned anytime for the outer threaded portion 23 to disengage from the inner threaded portion 15 of the tea cup 10, as shown in FIG. 5, to form a passage 26 between the bottom portion 22 of the tea infuser 20 and the partition 11 of the tea cup 10, such that the water outlet 24 is in communication with the through hole 14 and the tea in the tea brewing room 21 of the tea infuser 20 flows from the water outlet 24 through the passage 26 and the through hole 14 to enter the tea room 12 of the tea cup 10. For next tea brewing, as shown in FIG. 6, the tea infuser 20 is turned reversely, enabling the outer threaded portion 23 of the tea infuser 20 to engage with the inner threaded portion 15 of the tea cup 10. The passage 26 between the water outlet 24 and the through hole 14 is closed, so that the water outlet 24 is not in communication with the through hole 14. The user can invert the tea cup 10 and open the bottom cover 30 to drink the tea in the tea room 12. As shown in FIG. 4, after the tea is brewed in the tea brewing room 21 of the tea infuser 20 each time, through rotation of the tea infuser 20, the tea is discharged from the tea brewing room 21 to be stored in the tea room 21 for use. The tea in the tea brewing room 21 flows to the passage 26 from the water outlet 24 and then enters the tea room 12 from the through hole 14, as shown in FIG. 5. During the process, the air in the tea room 12 is expelled to the passage 26 from the through hole 14 when the tea is poured and then flows to the tea brewing room 21 through the air hole 250 of the air pipe 25 (there is no pressure accumulated in the passage 26), so that the tea in the tea brewing room 21 can be discharged to the tea room 12 smoothly.

According to the aforesaid embodiment, as shown in FIG. 1 and FIG. 2, the outer wall of the bottom portion 22 of the tea infuser 20 is further formed with a neck portion 27. The neck portion 27 is provided with an annular engaging rib 28. The engaging rib 28 is coupled with a soft rubber member 60. The soft rubber member 60 has a rubber plate 61 attached to the bottom surface of the bottom portion 22. The rubber plate 61 has a perforation 62 and a vent 63 corresponding to the water outlet 24 and the air hole 250 respectively. As shown in FIG. 4, when the outer threaded portion 23 of the tea infuser 20 and the inner threaded portion 15 of the tea cup 10 are locked tightly, the rubber plate 61 of the soft rubber member 60 is compressed between the bottom portion 22 and the partition 11 to improve the sealing function for blocking the communication between the water outlet 24 and the through hole 14 as well as the communication between the air hole 250 and the through hole 14. When the tea is brewed in the tea brewing room 21 of the tea infuser 20, the tea won't flow to the tea room 12 of the tea cup 10.

According to the aforesaid embodiment, as shown in FIG. 1, FIG. 2 and FIG. 3, the bottom portion 22 of the tea infuser 20 is formed with the water outlet 24. The tea infuser 20 is further provided with a filter screen 29 disposed above the water outlet 24 of the bottom portion 22. As shown in FIG. 5, the filter screen 29 is configured to filter the tea leaves 50 when the tea in the tea brewing room 21 of the tea infuser 20 is discharged to the tea room 12 of the tea cup 10 through the passage 26.

According to the aforesaid embodiment, as shown in FIG. 1, FIG. 2 and FIG. 3, the air pipe 25 is provided with a reinforcement piece 251 connected with the inner wall of the tea brewing room 21 of the tea infuser 20. The reinforcement piece 251 is to reinforce the connection between the pipe wall of the air pipe 25 and the inner wall of the tea brewing room 21. As shown in FIG. 4, when the tea leaves 50 are brewed in the tea brewing room 21, the air pipe 25 can be kept uprightly in the tea brewing room 21 through the reinforcement piece 251.

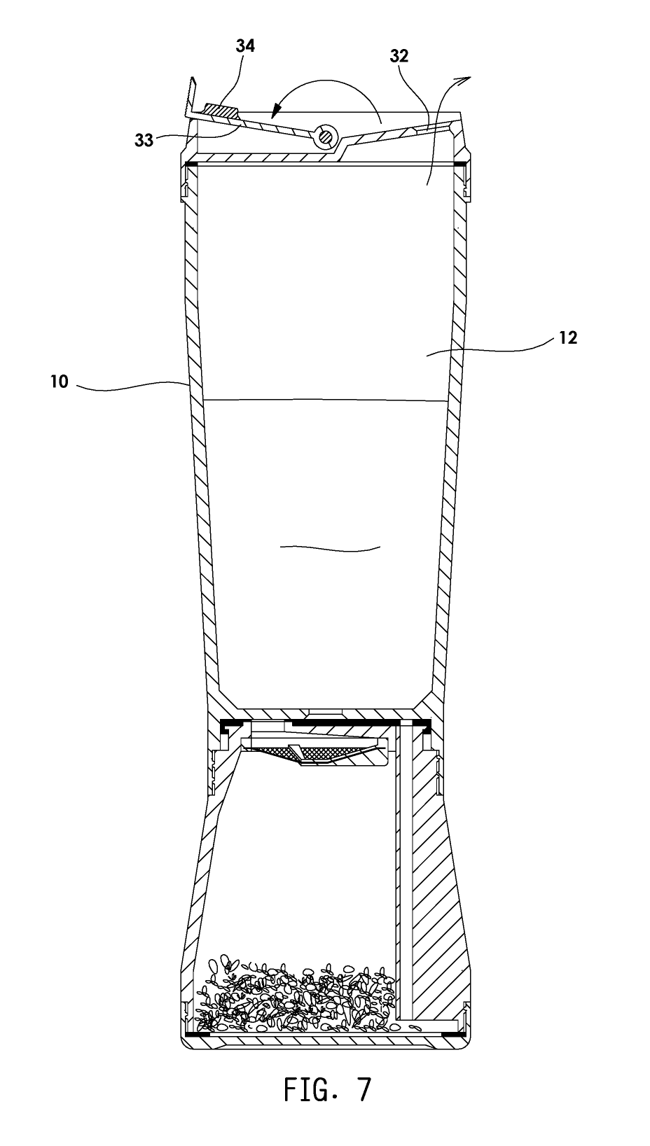

According to the aforesaid embodiment, as shown in FIG. 1 and FIG. 2, the bottom cover 30 has a faceplate 31. The faceplate 31 is formed with an outlet 32. An outer side of the faceplate 31 is pivotally connected with a lid 33. One end of the lid 33 is provided with a plug 34 facing the outlet 32. The plug 34 is plugged into the outlet 32 to seal the outlet 32 when the tea room 12 is stored with the tea, as shown in FIG. 6. As shown in FIG. 7, when the tea cup 10 is inverted, the lid 33 can be pivoted and opened and the plug 34 is disengaged from the outlet 32, so that the tea in the tea room 12 can be poured out conveniently and quickly from the outlet 32 for use.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A rotary tea maker, comprising a tea cup and a tea infuser; a bottom end of the tea cup being provided with a detachable bottom cover, an upper portion of the tea cup being provided with a partition therein to partition the tea cup into a tea room and a coupling trough, the partition being formed with a through hole for the tea room to communicate with the coupling trough, an inner wall of the coupling trough being formed with inner threaded portion; a top end of the tea infuser being provided with a detachable upper cover, the tea infuser having a tea brewing room therein and a bottom portion at a lower end thereof, an outer wall of the bottom portion being formed with an outer threaded portion to mate with the inner threaded portion of the tea cup, the bottom portion being further formed with a water outlet, the water outlet and the through hole of the tea cup being staggered; characterized in that: the bottom portion of the tea infuser is formed with an air pipe extending toward the tea brewing room to approach the upper cover, the air pipe and the through hole of the tea cup are staggered, and the air pipe has an air hole therein, enabling the bottom portion to communicate with the tea brewing room.

2. The rotary tea maker as claimed in claim 1, wherein the outer wall of the bottom portion of the tea infuser is further formed with a neck portion, the neck portion is provided with an annular engaging rib, the engaging rib is coupled with a soft rubber member, the soft rubber member has a rubber plate attached to a bottom surface of the bottom portion, and the rubber plate has a perforation and a vent corresponding to the water outlet and the air hole respectively.

3. The rotary tea maker as claimed in claim 1, wherein the tea infuser is provided with a filter screen disposed above the water outlet of the bottom portion.

4. The rotary tea maker as claimed in claim 1, wherein the air pipe is provided with a reinforcement piece connected with an inner wall of the tea brewing room of the tea infuser.

5. The rotary tea maker as claimed in claim 1, wherein the bottom cover has a faceplate, the faceplate is formed with an outlet, an outer side of the faceplate is pivotally connected with a lid, one end of the lid is provided with a plug facing the outlet, and the plug is plugged into the outlet to seal the outlet.
